(19) United States
(12) Patent Application Publication
(10) Pub. No.: US 2020/0130745 A1
(43) Pub. Date: Apr. 30, 2020

(54) METHOD AND APPARATUS FOR VEHICLE SIDE TRAILER DETECTION

(71) Applicant: GM GLOBAL TECHNOLOGY OPERATIONS LLC, Detroit, MI (US)

(72) Inventors: Gregory Cooke, Oshawa (CA); Ralph D. Schlottke, Whitby (CA); Shiv G. Patel, Brampton (CA)

(21) Appl. No.: 16/175,265

(22) Filed: Oct. 30, 2018

(51) Int. Cl. B62D 15/02; B60D 1/62

(52) U.S. Cl. CPC B62D 15/025; B60D 1/62

(57) ABSTRACT

The present application generally relates to a method and apparatus for vehicle side trailer detection in a motor vehicle. In particular, the system is operative to determine a trailer connection by activating a trailer lighting circuit and detecting a signal on a pin of the trailer connection. A signal generator and a switch are housed within the trailer connector such that the switch is depressed and the signal generator is activated in response to an insertion of a plug within the trailer connector.

### BACKGROUND

The present disclosure relates generally to automatically detecting a trailer for use with a vehicle. More specifically, aspects of the present disclosure relate to systems, methods and devices for determining the presence of a trailer connection for use in a driver assist vehicle including detecting a trailer without a continuous path allowing for a more robust and higher safety integrity rating for trailer detection.

As autonomous vehicle, or automated driving assist features on vehicles, become more ubiquitous, compensating for a trailer attached to the vehicle will become necessary to ensure proper handling and control of the vehicle. A trailer will change the handling characteristics of the vehicle depending on the vehicle, trailer size and trailer load. Current autonomous and driver assist vehicles have no ability to detect a trailer with no continuous electrical path, such as with an open ground. It would be desirable to overcome this issue in order to increase trailer detection to automotive safety integrity level (ASIL) B or higher and to establish a solution that does not require changing connector design from the standard existing seven pin trailer connector.

The above information disclosed in this background section is only for enhancement of understanding of the background of the invention and therefore it may contain information that does not form the prior art that is already known in this country to a person of ordinary skill in the art.

### SUMMARY

Disclosed herein are trailer detection methods and systems and related control logic for provisioning vehicle sensing and control systems, methods for making and methods for operating such systems, and motor vehicles equipped with onboard sensor and control systems. By way of example, and not limitation, there is presented various embodiments of a passive diagnostic circuit designed to aid the existing Trailer Interface Module (TIM) or equivalent in trailer detection, including detecting a trailer without a continuous path, or open ground, are disclosed herein.

In accordance with an aspect of the present invention, an apparatus comprising a switch wherein the switch is activated in response to an insertion of a trailer wiring plug inserted into a trailer wiring connector, a signal generator for generating a signal coupled between the switch and a voltage supply line of the trailer wiring connector and wherein the switch is further coupled to a ground line of the trailer wiring connector, a processor for initiating the voltage supply line and detecting a signal from the signal generator, the processor being further operative to select a vehicle parameter in response to detecting the signal, and a vehicle controller for controlling a driving assisted vehicle in response to the parameter.

In accordance with another aspect of the present invention a trailer detection system comprising a socket for receiving an electrical connector from a trailer wherein the socket has a power pin and a ground pin, a switch positioned within the socket wherein the switch is activated in response to an insertion of the electrical connector into the socket, a signal generator for generating a signal coupled between the power pin and the switch, a resonant circuit coupled between the power pin and the ground pin, a processor for energizing the power pin and detecting the signal on the ground pin, the processor further operative to generate a control signal in response to detecting the signal, and a controller for controlling a driving assisted vehicle in response to the control signal.

In accordance with another aspect of the present invention a method for receiving a request for an activation of an assisted driving algorithm, energizing a trailer light circuit in response to the request, receiving a signal in response to energizing the trailer light circuit wherein the signal is generated by a signal generator within a trailer connector, selecting a parameter in response to receiving the signal, and controlling a driving assisted vehicle in response to the parameter.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an exemplary application of the method and apparatus for vehicle side trailer detection in a motor vehicle according to an embodiment of the present disclosure.

FIG. 2 shows a diagram illustrating an exemplary system for vehicle side trailer detection in a motor vehicle according to an embodiment of the present disclosure.

FIG. 3 shows an exemplary circuit for vehicle side trailer detection according to an embodiment of the present disclosure.

FIG. 4 shows a flowchart illustrating an exemplary method for vehicle side trailer detection according to an embodiment of the present disclosure

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

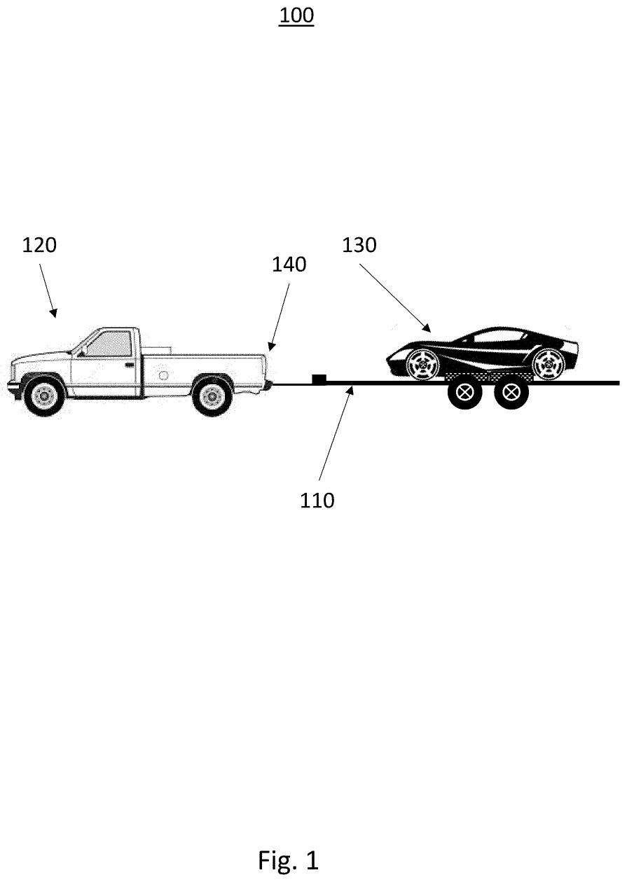

FIG. 1 schematically illustrates an exemplary application of the method and apparatus for vehicle side trailer detection in a motor vehicle 100 according to the present disclosure. In this exemplary embodiment, a towing vehicle 120 featuring the vehicle side trailer detection system is used in detecting an attached trailer 110 with a trailer load 130. In the description of this exemplary embodiment the trailer load is a loaded vehicle 120, but the presently disclosed system and method are applicable to any load. The towing vehicle 120 is equipped with a trailer electrical connection with the exemplary trailer detection system 140. In addition, the system may be operative to transmit a signal to a user device, such as a cellular phone, smartwatch, Bluetooth device, etc. The trailer detection system 140 can be integrated into a standard seven pin trailer electrical connector and is operational in the event of a faulty ground connection within the trailer electrical connector and/or wiring system.

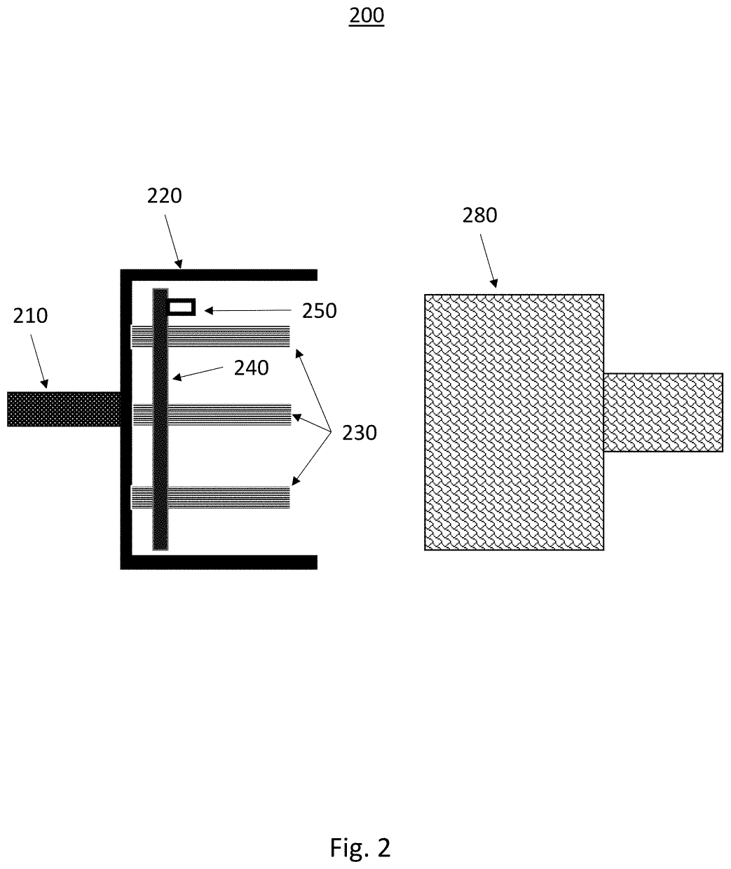

Turning now to FIG. 2, a diagram illustrating an exemplary system for vehicle side trailer detection in a motor vehicle 200 is shown. The exemplary system is operable to detect a connection to a trailer without continuity and can be integrated into a standard trailer connector 220. The standard trailer connector 220 is typically mounted to the vehicle and has a socket for receiving a trailer connector 280 which is electrically coupled to the trailer electrical system. The standard trailer connector 220 includes a number of pins 230 and an electrical connection 210 to a trailer sensing module. As part of the exemplary embodiment of the vehicle side trailer detection system, a circuit board 240 having a push button 250 is installed inside the standard trailer connector 220.

The exemplary vehicle side trailer detection system comprises a circuit board 240 that is installed into the rear of the vehicle-side connector 220. The circuit board 240 is operational to provide flexibility in that the connector-shaped printed circuit board fits into the vehicle side connector 220 without interfering with trailer connector seating, contact, or operation. The circuit board 240 is operative to send a current signal to the trailer sensing module through one of the seven pins available once the button switch is closed. Furthermore, the circuit board 240 offers a physical means of detection independent of continuity method to be used in conjunction for a higher degree of detection confidence.

The trailer sensing module is operative to detect a trailer with or without a ground connection which will receive the signal output by the circuit board 240. The trailer sensing module may be operative to use the detection information to disable active safety features such as lane change on demand, and allow the activation of the assisted driving features with trailering options. The proposed method is advantageous over existing methods is that it uses a trailer circuit continuity to determine if a trailer is connected. The proposed passive circuit does not interfere with trailer light operation by using a low-current signal to be sensed by trailer control module in the vehicle

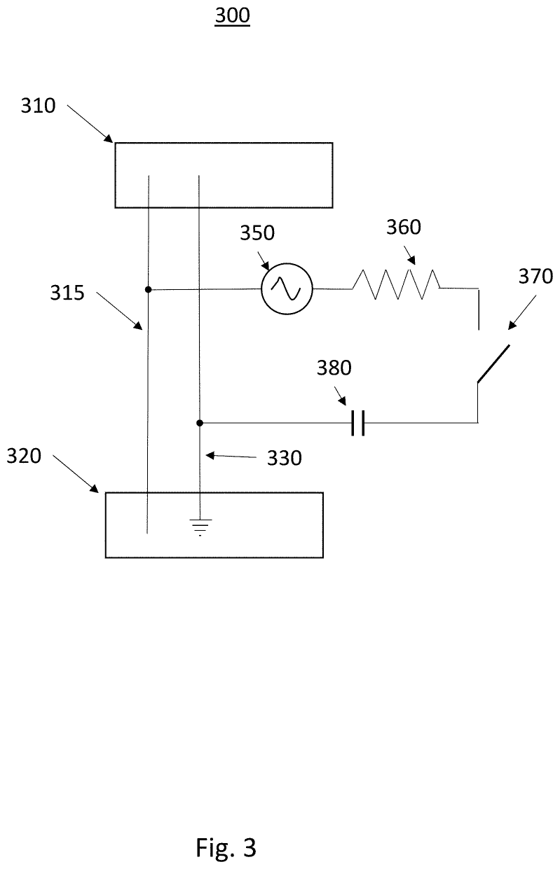

Turning now to FIG. 3, an exemplary circuit 300 for vehicle side trailer detection in a motor vehicle is shown. The circuit 300 may be implemented on a removable circuit board as described previously, or may be mounted directly into the standard trailer connector 320. The circuit 300 is positioned such that it is connected between the pins of the standard trailer connector 320 and the trailer electrical connector 310. The circuit 300 may be connected to any of the active trailer pins, such as the trailer turn lamp/stop lamp left, trailer turn lamp/stop lamp right, trailer battery supply, trailer tail lamps, etc. For this exemplary embodiment, the circuit 330 will be connected to the trailer turn lamp/stop lamp left pin 315. A pulse width modulated current source 350 is connected to the trailer turn lamp/stop lamp left pin 315. The current source 350 is activated when the trailer turn lamp/stop lamp left pin 315 is energized. The circuit further includes a resistance 360 and a capacitance 380 resulting in a tuned RC response when the switch 370 is closed. The switch 370 can be physically closed by inserting the trailer electrical connector 310 into the standard trailer connector 320. Alternatively, the resistance 360 and capacitance 380 may operate as the current source when the lamp switches between high voltage and low voltage.

The exemplary circuit 310 is operative to connects a pin of the connector to the ground pin through a series circuit consisting of a capacitor 380, resistor 360, and switch 370. When a trailer electrical connector 310 is plugged into the vehicle-side connector, the push button is depressed by the insertion force and the switch 370 is closed by the trailer electrical connector 310. The RC circuit is tuned to output a small current signal that can be sensed by the trailer sensing module in order to indicate trailer connection. Trailer connection status may lead to enabling/disabling vehicle features

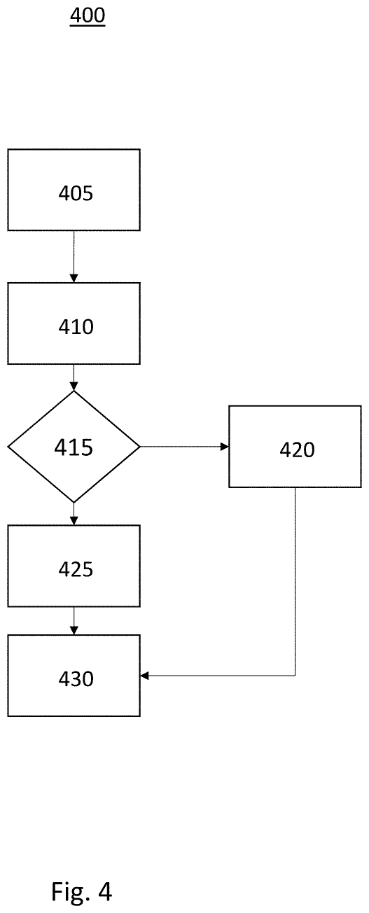

Turning now to FIG. 4 a flowchart illustrating an exemplary method for vehicle side trailer detection 400 according to another embodiment of the present disclosure is shown. The method is first operative to receive a command to initiate a driving automation program 405. In this exemplary embodiment, the method is then operative to initiate the trailer lights 410. Initiating the trailer lights will activate the circuit on the circuit board on the vehicle side connector if the switch is depressed by the trailer connector. The method is then operative to check to see if a signal is received from the circuit 415. If no signal is received, the method determines that no trailer has been connected and driving parameters are loaded by the system program consistent with a trailer not being present 420 and the method then proceeds with the driving automation program 430. If a signal is received, the method determines that a trailer is connected and driving parameters are loaded by the system program consistent with a trailer being present 425 and the method proceeds with driving automation. Alternatively, the method may determine that a trailer is attached and inactivate the driving automation program. The method may further deactivate an active safety feature of the vehicle in response to detection of the trailer connection.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A apparatus comprising:
a switch wherein the switch is activated in response to an insertion of a trailer wiring plug inserted into a trailer wiring connector;
a signal generator for generating a signal coupled between the switch and a voltage supply line of the trailer wiring connector and wherein the switch is further coupled to a ground line of the trailer wiring connector;
a processor for initiating the voltage supply line and detecting a signal from the signal generator, the processor being further operative to select a vehicle parameter in response to detecting the signal; and
a vehicle controller for controlling a driving assisted vehicle in response to the parameter.

2. The apparatus of claim 1 further comprising a resistor and a capacitor coupled between the switch and the signal generator and wherein the signal is a pulse width modulated voltage signal.

3. The apparatus of claim 1 wherein the parameter is indicative of a trailer connected to the driving assisted vehicle.

4. The apparatus of claim 1 wherein the trailer detection circuit is housed within the trailer wiring connector.

5. The apparatus of claim 1 wherein the parameter is indicative of a handling characteristic of the vehicle towing the trailer.

6. The apparatus of claim 1 wherein signal generator is formed by a resistor and a capacitor and wherein the signal is generated in response to a change in a voltage level of the voltage supply line.

7. The apparatus of claim 1 wherein the voltage supply line is initiated in response to a request to initiate a driving assistance algorithm.

8. A method comprising:
receiving a request for an activation of an assisted driving algorithm;
energizing a trailer light circuit in response to the request;
receiving a signal in response to energizing the trailer light circuit wherein the signal is generated by a signal generator within a trailer connector;
selecting a parameter in response to receiving the signal; and
controlling a driving assisted vehicle in response to the parameter.

9. The method of claim 8 wherein the assisted driving algorithm is a lane centering vehicle steering system.

10. The method of claim 8 wherein the parameter is indicative of a trailer connected to the driving assisted vehicle.

11. The method of claim 8 wherein the signal generator is housed within a trailer wiring connector.

12. The method of claim 8 wherein the parameter is indicative of a handling characteristic of the driving assisted vehicle towing a trailer.

13. The method of claim 8 wherein signal generator is a current generator and the signal is a sinusoidal signal.

14. The method of claim 8 further comprising deenergizing the trailer light circuit in response to receiving the signal.

15. A trailer detection system comprising:
a socket for receiving an electrical connector from a trailer wherein the socket has a power pin and a ground pin;
a switch positioned within the socket wherein the switch is activated in response to an insertion of the electrical connector into the socket;
a signal generator for generating a signal coupled between the power pin and the switch;
a resonant circuit coupled between the power pin and the ground pin;
a processor for energizing the power pin and detecting the signal on the ground pin, the processor further operative to generate a control signal in response to detecting the signal; and
a controller for controlling a driving assisted vehicle in response to the control signal.

16. The trailer detection system of claim 15 wherein the resonant circuit includes a resistor and a capacitor.

17. The trailer detection system of claim 15 wherein the control signal is indicative of a trailer connected to the driving assisted vehicle.

18. The trailer detection system of claim 15 wherein the signal generator is housed within the socket.

19. The trailer detection system of claim 15 wherein the controls signal is indicative of a handling characteristic of the driving assisted vehicle towing a trailer.

20. The trailer detection system of claim 15 further comprising deactivating an active safety feature of the driving assisted vehicle in response to the control signal.
